(19) United States
(12) Patent Application Publication
(10) Pub. No.: US 2002/0148904 A1
(43) Pub. Date: Oct. 17, 2002

(54) Multi-functional /nozzle for photoresist developer dispenser

(76) Inventor: Wen-Cheng Yu, Ilan (TW)

Correspondence Address: Hung Chang LIN, 8 Schindler Court, Silver Spring, MD, 20903, US

(21) Appl. No.: 09/835,971

(22) Filed: Apr. 17, 2001

(51) Int. Cl. A01G 27/00

(52) U.S. Cl. 239/69; 239/70; 239/398; 239/418; 239/433

(57) ABSTRACT

Different kinds of developing liquids for photolithography are stored in separate chambers. The stored liquids are dispensed in a single nozzle head which merges the outlets of the two storage chambers. The mix of the liquids can be programmed. In another embodiment of the invention, each separate chamber has individual nozzle head, but the chambers are mechanically integrated as a unitary body, capable of moving and spraying together.

### BACKGROUND OF THE INVENTION

This invention relates to photolithography of integrated circuits, in particular to the nozzle for developers of photoresist used in photolithography.

In processing semiconductor, photolithography is used to pattern the features of the different components. In photolithography, an oxidized semiconductor wafer is first coated with a layer of photoresist, which is exposed to light through a mask. The exposed photoresist is developed with a developer to form a mask against subsequent etching of the underlying oxide. Then impurities can be selectively ion-implanted or diffused through the windows opened by the etched oxide to form PN junctions. Similarly, metal interconnections can also be delineated by phtolithography.

The developer chosen depends on the type of photoresist used. For instance, the developer for positive photoresist is different from that for negative photoresist. Traditionally, the developer is dispensed through an E2 nozzle in a so-called “Clean Track” equipment. The purpose of the E2 nozzle is to conserve the developer liquid. The structure of the E2 nozzle is shown in FIGS. 1a and 1b, where FIG. 1a is the front view and FIG. 1b is the side view. The developer is supplied from the top of the E2 nozzle and is dispensed at the bottom through a number of nozzle heads to spray on the exposed wafers.

The traditional E2 nozzle has a shortcoming in that it can only accommodate one kind of developer. If two or more kinds of liquids are needed, the clean track equipment must be equipped with two sets of E2 nozzle. As a result, the bulk of the equipment is greatly increased. Two kinds of developers cannot coexist in the same nozzle.

### SUMMARY

An object of this invention is to construct a developer dispenser which can accommodate different kinds of developer. Another object of this invention is to construct an E2 nozzle for the dispenser which does not occupy a big volume. Still another object of this invention is to be able to program the mix of the developer and de-ionized water dispensed from the E2 nozzle.

These objects are obtained by storing different kinds of liquid in separate storage chambers but are dispensed in a single nozzle head by merging the outlets of the two chambers. In another embodiment, each chamber has an individual nozzle head, but the two chambers are mechanically integrated as a unitary body so the liquids can be sprayed at the same time.

### BRIEF DESCRIPTION OF THE DRAWINGS

FIG. 1a and FIG. 1b show the front view and side view of a prior art E2 nozzle for photoresist developer, respectively.

FIG. 2a and FIG. 2b show the front view and side view of an E2 nozzle based on the present invention.

FIG. 3 show another embodiment of the E2 nozzle based on the present invention.

### DETAILED DESCRIPTION OF THE PREFERRED EMBODIMENT

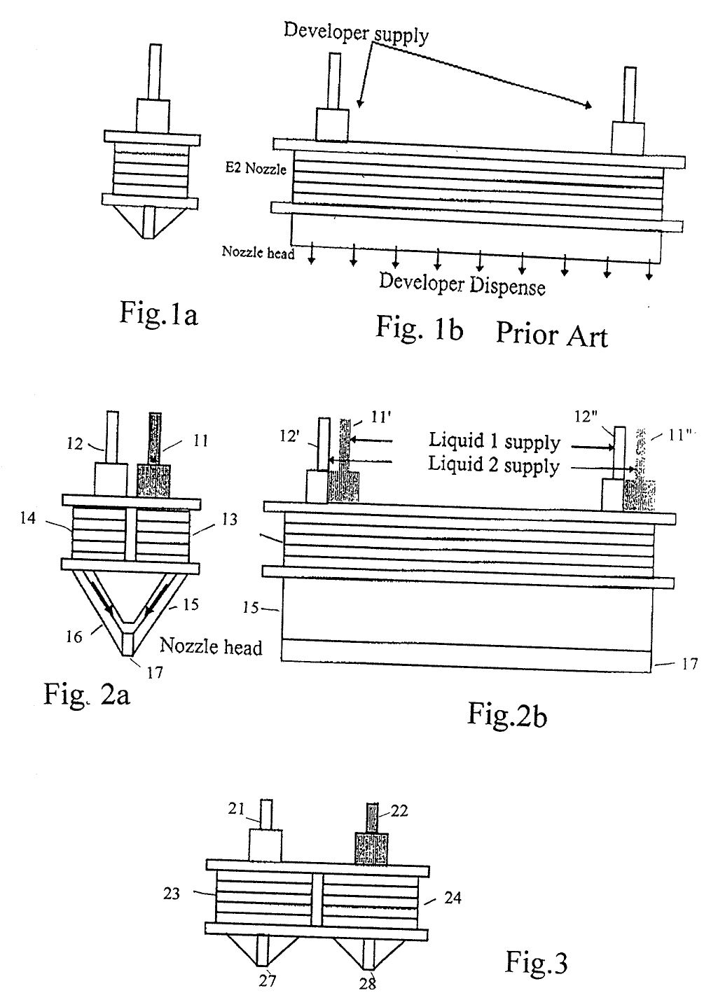

FIG. 2a shows the side view of the dispenser with a new E2 nozzle based on this invention, FIG. 1b shows the right side view of the dispenser. The dispenser has two liquid inlets 11 and 12: inlet let 11 for liquid 1 and inlet 12 for liquid 2. Each kind of liquid can have more than one inlet, such as inlets 11′. 11″ for liquid 1 and inlets 12′, 12″ for liquid 2 as shown in the right view FIG. 1b. Liquid 1 and liquid 2 are stored in chambers 14 and 15, respectively. The liquids stored in the chambers are fed through two conduits 15 and 16 formed in V-shape and merged at the lower tip to become a single outlet nozzle head 17. Such a nozzle can be used to spray different kinds of liquid or different mix of the liquids on wafers, such as positive resist developer, negative resist developer, deionized (DI) water, etc. The different mix can be timed to spray according to a program. Thus this new nozzle has a great deal of flexibility and saves a great deal of space.

Another embodiment of the present invention is shown in FIG. 3. In this figure, there are two inlets 21 and 22 for two different kinds of liquid feeding two separate chambers 23 and 24 respectively. These two chambers are mechanically held together as a unitary nozzle head, but are isolated from each other chemically. Each chamber has an outlet nozzle, i.e. outlet nozzle 27 for chamber 23 and outlet nozzle 28 for chamber 24. The separate nozzles can avoid the mixing of the two kinds of liquids, but capable of moving and spraying the different liquids at the same time.

The advantages of the present invention are:

1). The dispenser can accommodate many kinds of liquid;

2) The size of the dispenser is small;

3) The different mix of liquids at the outlet of the dispenser can be easily programmed.

While the preferred embodiments of the invention have been shown and described, it will be apparent to those skilled in the art that various modifications may be made in the embodiments without departing from the spirit of the present invention. Such modifications are all within the scope of this invention.

What is claim is:

1. A nozzle for photoresist developer in photolithography for processing a semiconductor wafer, comprising:
more than one inlet each for a different kind of liquid;
more than one chamber each for storing said different kind of liquid; and
a nozzle head which merges the liquids from said more than one chamber as a single nozzle head for dispensing said liquids.

2. A nozzle as described in claim 1, wherein there are two inlets for two different kinds of liquids, two chambers for storing said two different kinds of liquids, and a nozzle head which merges the liquids from said two chambers.

3. A nozzle as described in claim 2, wherein said nozzle head is fed from said two chambers through two conduits.

4. A nozzle as described in claim 3, wherein said two conduits are formed in V-shape.

5. A nozzle as described in claim 1, wherein said liquid is selected from a group consisting of positive photoresist, negative photoresist and de-ionized water.

6. A nozzle as described in claim 1, wherein the dispensing of said liquid is programmed by a timer.

7. A nozzle for photoresist developer in photolithography for processing a semiconductor wafer, comprising:
more than one inlet, each for a different kind of liquid,
more than one chamber each for storing of said different kind of liquid, isolated from each in liquid content, but mechanically connected to form a unitary body; and
more than one nozzle head each connected to said chamber for dispensing said different kind of liquid.

8. A nozzle as described in claim 7, wherein there are two inlets for two different kinds of liquid, two chambers for storing said two kinds of liquid, and two nozzle heads each connected to said two chambers.

9. A nozzle as described in claim 7, wherein said liquid is selected from a group consisting of positive resist developer, a negative resist developer and de-ionized water.

10. A nozzle as described in claim 7, wherein the dispensing of said liquid is programmed by a timer.
